(19) United States
(12) Patent Application Publication
(10) Pub. No.: US 2019/0116770 A1
(43) Pub. Date: Apr. 25, 2019

(54) FISHING LURE

(71) Applicant: Bryan Thompson, Sioux Lookout (CA)

(72) Inventor: Bryan Thompson, Sioux Lookout (CA)

(21) Appl. No.: 16/168,806

(22) Filed: Oct. 23, 2018

Related U.S. Application Data
(60) Provisional application No. 62/575,895, filed on Oct. 23, 2017.

(51) Int. Cl. A01K 85/12; A01K 85/18

(52) U.S. Cl. CPC A01K 85/12; A01K 85/18

(57) ABSTRACT

A fishing lure is configured to optimally provide anglers and fishermen with a spinner bait lure designed to catch big fish in freshwater locations. The fishing lure is configured to attach conveniently to any type of fishing rod via a rear attachment ring. The fishing rod may include a bullet-shaped main body with multiple spinner blades and additional weight designed for longer casts enabling fishermen to customize the lure with ornamental feathers and other attachments.

### CROSS REFERENCE TO RELATED APPLICATION

The present application is related to and claims priority to U.S. Provisional Patent Application Number 62/575,895 filed Oct. 23, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of fishing equipment and more specifically relates to fishing lures.

### 2. Description of Related Art

Many people fun for food or for sport. It can be discouraging to spend a long day fishing and not catch any big fish. While people may enjoy relaxing on the water, catching fish is fun and entertaining. Anglers may be looking for better bait and lures in order to land big catches. Many people enjoy fishing. Fishing is the activity of trying to catch fish. Fish are normally caught in the wild. Techniques for catching fish include hand gathering, spearing, netting, angling and trapping. Fishing may also include catching aquatic animals other than fish, such as crustaceans and the like. A suitable novel solution for catching fish is desired.

U.S. Pat. No. 5,890,315 to Don S. Norton relates to a fishing lure with a firearm shell casing. The described fishing lure with firearm shell casing includes an empty firearm ammunition shell casing and a fishhook attached thereto. Soundwave-propagation is achieved by means of one or more rattle bead or beads freely housed within the interior cylindrical space of the shell casing to thereby attract game fish when the lure is submerged during use. Most preferably, the fishhook is attached rigidly to the rearward rim surface of the shell casing (e.g., in the pocket space in which the primer for the cartridge is seated) and protrudes rearwardly therefrom. A spoon or other decorative lure devices may optionally be attached to the shell casing to provide the fisherman with the desired effect.

### BRIEF SUMMARY OF THE INVENTION

In view of the foregoing disadvantages inherent in the known fishing equipment art, the present disclosure provides a novel fishing lure. The general purpose of the present disclosure, which will be described subsequently in greater detail, is to provide anglers with a spinner bait lure configured to catch big fish in freshwater locations. The fishing lure may attach conveniently to virtually any type of fishing rod via a rear attachment ring. The fishing lure may generally comprise a bullet-shaped main body having multiple spinner blades and an additional weight designed for longer casts. The fishing lure beneficially allows users to customize the lure with ornamental feathers and other attachments suitable for musky and/or pike fishing. The fishing lure may aid anglers in catching more fish while spending the day fishing.

A fishing lure is disclosed herein. The fishing lure may include a firearm cartridge case having a center axis, a firing end, a projectile end opposite the firing end, and an inside length extending along the center axis from the firing end to the projectile end.

The firearm cartridge case may include a cartridge base at the firing end and a circumferential wall extending from the cartridge base about and along the center axis to the projectile end. The cartridge base and the circumferential wall may form an inside cavity.

The fishing lure may further include a projectile-weight comprising a cartridge end and a tip end opposite the cartridge end, relative to the center axis. The projectile-weight may include an aperture passing through the projectile-weight, the projectile-weight may be configured to seat in the circumferential wall of the firearm cartridge case proximate the firing end of the firearm cartridge case.

The fishing lure may further include a wire line extending into the firearm cartridge case via the cartridge base, out of the firearm cartridge case at the projectile end, and through the projectile-weight via the aperture. The wire line may comprise a fishing pole end and a hook end, each being outside of the firearm cartridge case and the projectile-weight. The wire line may include a first attachment loop at the fishing pole end and a second attachment loop at the hook end.

The fishing lure may further include an annular spacer of substantially the same length as the inside length of the firearm cartridge case, the annular spacer being disposed inside the inside cavity of the firearm cartridge case and about the wire line and configured to rest against the cartridge base and maintain the projectile-weight positioned substantially outside of the cavity of the firearm.

A method of using a fishing lure is also disclosed herein comprising the steps of: step one, providing the fishing lure, the fishing lure comprising a firearm cartridge case, a projectile weight, a wire line, and an annular spacer; step two, inserting a wire line partially contained in a sheath into a firearm cartridge case, the wire line having a fishing pole end and a hook end, each extending out of the firearm cartridge case, wherein a bottom portion of the sheath contacts an inside bottom wall of the firearm cartridge case, and wherein a top portion of the sheath may be located adjacent the top end of the firearm cartridge case; step three, attaching a first fishing weight to the wire line adjacent an outside bottom end of the firearm cartridge case to prevent movement of the wire line in the direction of the firearm cartridge case; and step four, attaching a fishing hook to the wire line in contact with a bottom end of the sheath to allow for the catching of fish.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fishing lure, constructed and operative according to the teachings of the present disclosure.

FIG. 1 is an exploded view of the fishing lure comprising a firearm cartridge case, a projectile weight, a wire line, and an annular spacer, according to an embodiment of the disclosure.

FIG. 2 is a side view of the fishing lure in an assembled condition of FIG. 1, according to an embodiment of the present disclosure.

FIG. 3 is a cross-sectional view of an inside length of the firearm cartridge case of FIGS. 1 and 2, according to an embodiment of the present disclosure.

FIG. 4 is a perspective view of the fishing lure comprising a pair of spinner blades of FIG. 1, according to an embodiment of the present disclosure

FIG. 5 is a flow diagram illustrating a method of use for the fishing lure, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to fishing equipment and more particularly to a fishing lure as used to improve the quality of fishing.

Generally, the present disclosure comprises a fishing lure that is a visually-appealing and functional spinner bait for catching freshwater fish (such as musky and pike). The fishing lure may comprise a 0.30 caliber shell body having an additional weight in the main body. The fishing lure may include at least one spinner blade and a rear attachment ring. The extra weight may provide longer casts and optimization for drag conditions. The bait may be attached to a fishing rod and thrown into the water in order to catch fish.

The fishing lure may be constructed using metal, plastic, wire, and other suitable materials. The fishing lure may be equipped with ornamental decorations to further attract freshwater fish, along with adding flair and fun to the lure. In one embodiment, the fishing lure may measure approximately 8″ in length. However, exact size, measurement, construction, and design specifications may vary upon manufacturing.

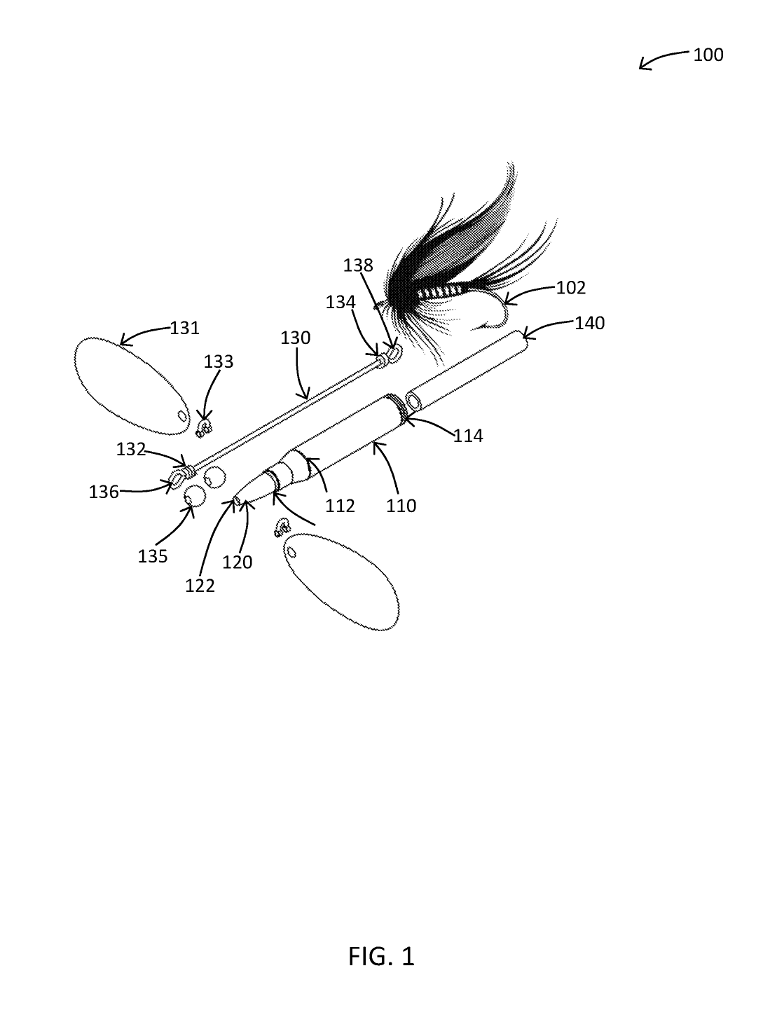

Referring now more specifically to the drawings by numerals of reference, there is shown in FIGS. 1-4, various views of a fishing lure 100 comprising a firearm cartridge case 110, a projectile weight 120, a wire line 130, and an annular spacer 140. A firearm cartridge case 110 may include a center axis 112, a firing end 114, a projectile end opposite the firing end 114, and an inside length 118 extending along the center axis 112 from the firing end 114 to the projectile end.

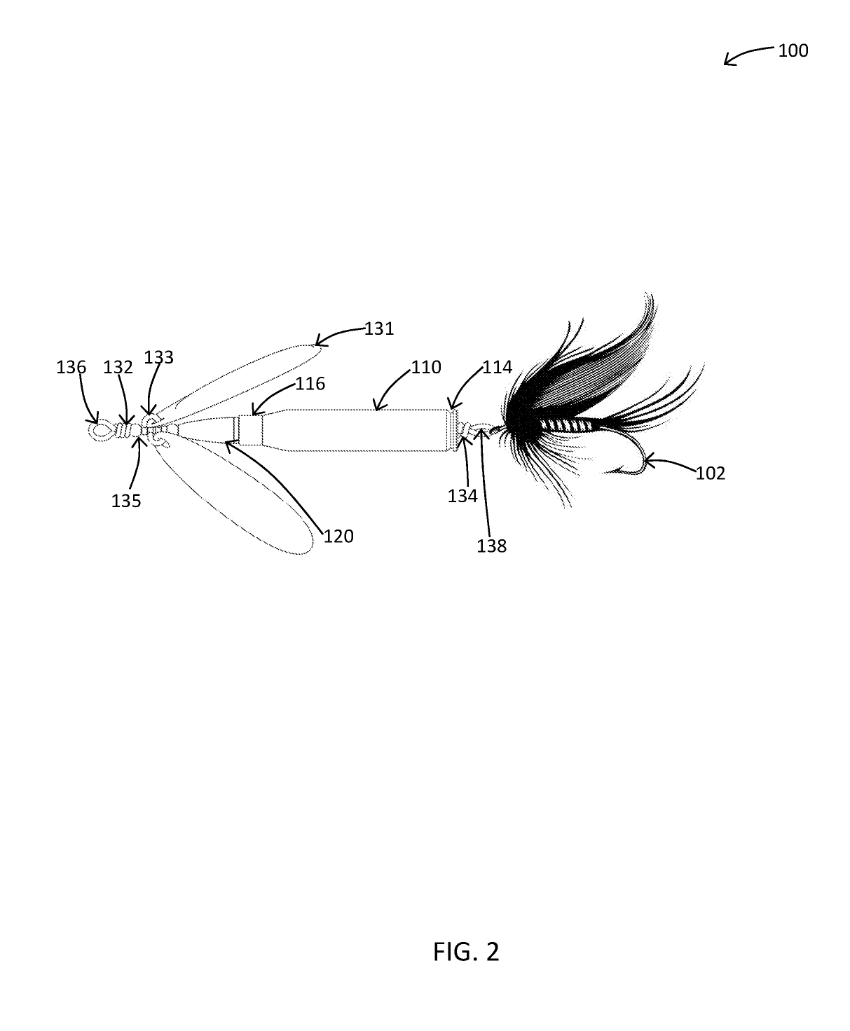

Referring to FIGS. 1 and 2, the firearm cartridge case 110 may include a cartridge base at the firing end 114 and a circumferential wall extending from the cartridge base about and along the center axis 112 to the projectile end, the cartridge base and the circumferential wall forming an inside cavity. As shown, the projectile-weight may have a cartridge end and a tip end 116 opposite the cartridge end, relative to the center axis 112. The projectile-weight includes an aperture 122 passing through the projectile-weight. The projectile-weight is configured to seat in the circumferential wall of the firearm cartridge case 110 proximate the firing end 114 of the firearm cartridge case 110.

FIG. 2 shows a side view of the fishing lure comprising: a firearm cartridge case, a projectile weight, a wire line, and an annular spacer 100 of FIG. 1, according to an embodiment of the present disclosure. As above, the fishing lure comprising: 100 may include a firearm cartridge case 110, a projectile weight 120, a wire line 130, and an annular spacer 140.

As shown, the wire line 130 may extend into the firearm cartridge case 110 via the cartridge base, out of the firearm cartridge case 110 at the projectile end, and through the projectile-weight via the aperture 122. The wire line 130 may have a fishing pole end 132 and a hook end 134, each being outside of the firearm cartridge case 110 and the projectile-weight. The wire line 130 includes a first attachment loop 136 at the fishing pole end 132 and a second attachment loop 138 at the hook end 134.

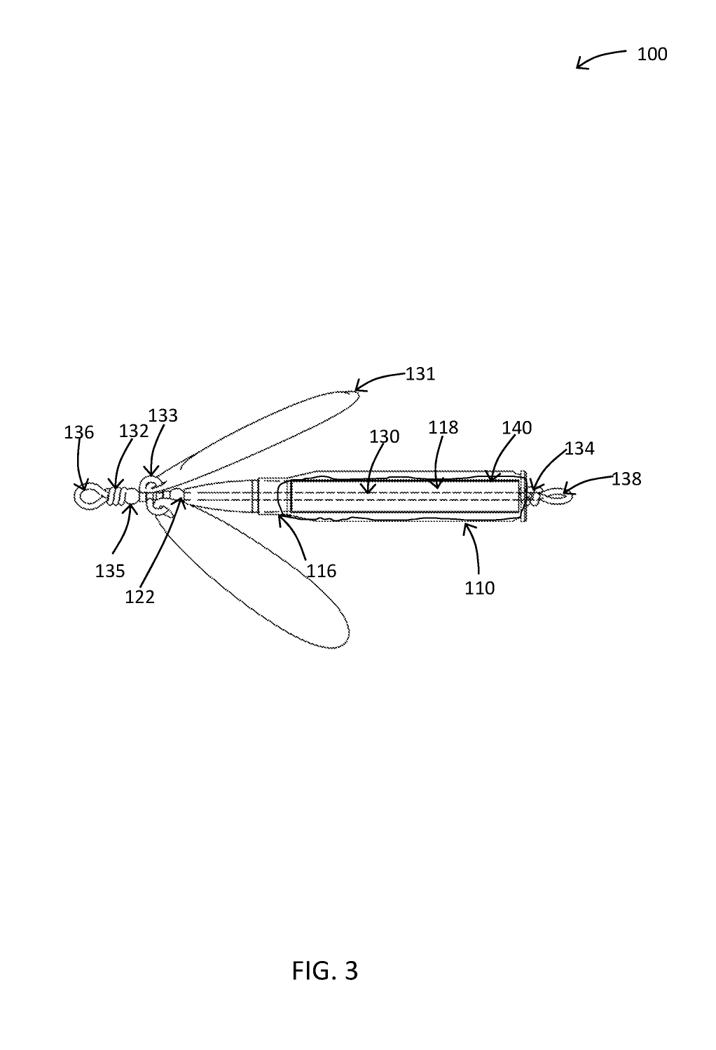

FIG. 3 shows a cross sectional view of the fishing lure comprising: a firearm cartridge case 110, a projectile weight 120, a wire line 130, and an annular spacer 140 of FIG. 1, according to an embodiment of the present disclosure. As above, the fishing lure 100 is shown further including an annular spacer 140. Preferably, the annular spacer 140 comprises substantially the same length as the inside length 118 of the firearm cartridge case 110. As shown, the annular spacer 140 is disposed inside the inside cavity of the firearm cartridge case 110 and about the wire line 130 and configured to rest against the cartridge base and maintain the projectile-weight positioned substantially outside of the cavity of the firearm. Further, the firearm cartridge case 110 includes an opening at the tip, the opening configured to allow the wire line 130 to run through the length of the firearm cartridge case 110.

In one embodiment, the projectile weight 120 may be silver in color. Preferably, the firearm cartridge case 110 is made of at least one of lead, metal, and plastic.

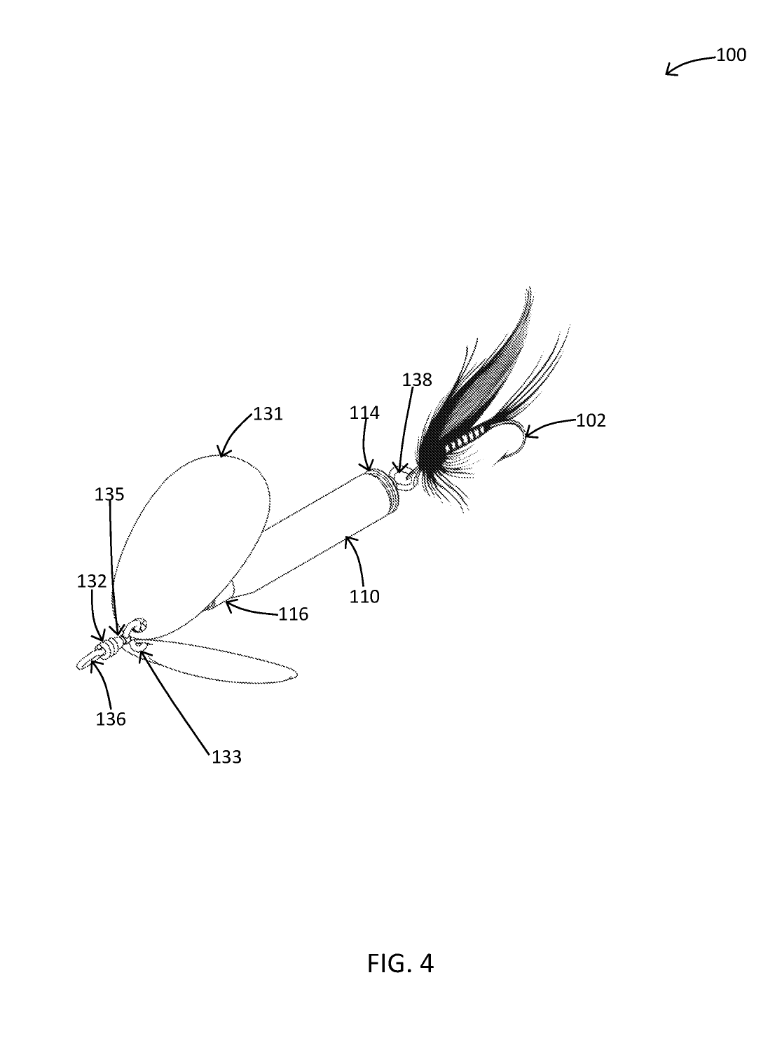

In referring now to FIG. 4, the fishing lure 100 may comprise at least one spinner blade 131 rotatably affixed to the wire line 130. The at least one spinner blade 131 may be attached to the wire line 130 via a clevis fastener 133 (or other suitable fastener) respectively. Each clevis fastener 133 may rotatably be attached to the wire line 130. As further shown, the fishing lure 100 further may comprise two fishing lure beads 135 rotatably attached to the wire line 130, each on opposite sides of the two clevis fasteners 133. In one embodiment, the firearm cartridge case 110 may be sized and dimensioned as a 30-caliber cartridge round case.

In yet another embodiment, the fishing line may be attached to the first attachment loop 136, wherein a hook may be attached to the second attachment loop 138, wherein the first attachment loop 136 at the fishing pole end 132 and the second attachment loop 138 at the hook end 134 are separated by a distance of approximately 3-5 inches; wherein the projectile weight 120 may be held in place by the tip end 116 of the firearm cartridge case 110. The annular spacer 140 sits next to the projectile weight 120 toward the firing end 114 of the firearm cartridge case 110, wherein the wire line 130 runs through the annular spacer 140 within the firearm cartridge casing. In this embodiment the wire line 130 runs through the annular spacer 140 within the firearm cartridge casing, wherein the wire line 130 runs through the annular spacer 140 within the firearm cartridge casing. As designed the wire line 130 runs through the annular spacer 140 within the firearm cartridge casing.

According to one embodiment, the fishing lure 100 may be arranged as a kit. The kit may include fishing lure in the shape of a bullet having two spinners, and a set of user instructions. The instructions may detail functional relationships in relation to the structure of the fishing lure 100 (such that the fishing lure 100 can be used, maintained, or the like, in a preferred manner).

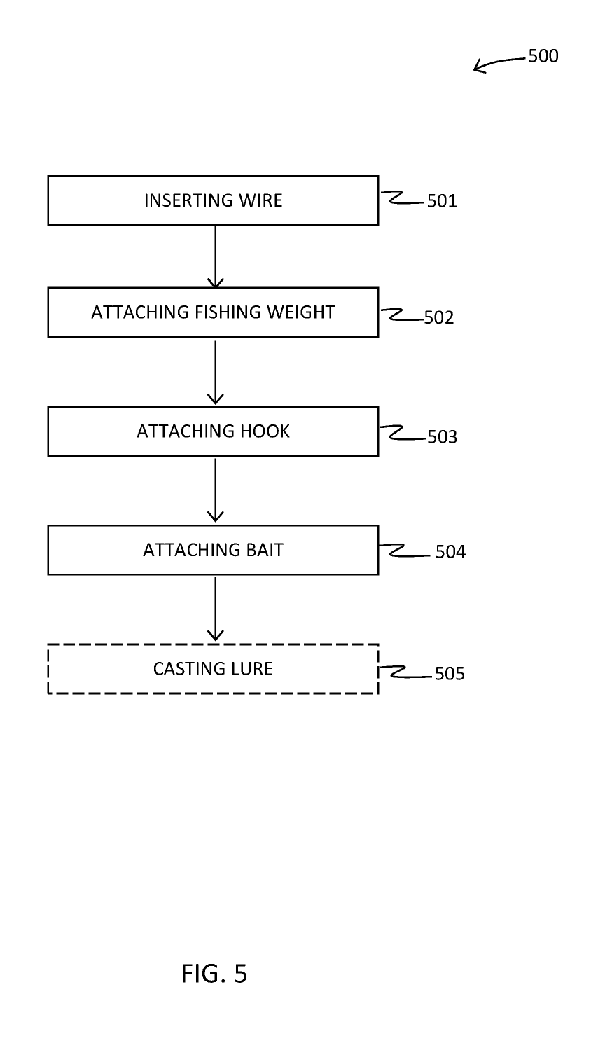

FIG. 5 is a flow diagram illustrating a method of use 500, according to an embodiment of the present disclosure. As illustrated, the method 500 may include the steps of: step one 501, providing the fishing lure, the fishing lure comprising a firearm cartridge case, a projectile weight, a wire line, and an annular spacer; step two 502, inserting a wire line partially contained in a sheath into a firearm cartridge case, the wire line having a fishing pole end and a hook end, each extending out of the firearm cartridge case, wherein a bottom portion of the sheath contacts an inside bottom wall of the firearm cartridge case, and wherein a top portion of the sheath may be located adjacent the top end of the firearm cartridge case; step three 503, attaching a first fishing weight to the wire line adjacent an outside bottom end of the firearm cartridge case to prevent movement of the wire line in the direction of the firearm cartridge case; step four 504, attaching a fishing hook to the wire line in contact with a bottom end of the sheath to allow for the catching of fish step five, and step 505 which is casting the fishing lure into a body of water.

It should be noted that step six 505 is an optional step and may not be implemented in all cases. Optional steps of method of use 500 are illustrated using dotted lines in FIG. 4 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the a fishing lure comprising: a firearm cartridge case, a projectile weight, a wire line, and an annular spacer 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fishing lure comprising:
a firearm cartridge case having a center axis, a firing end, a projectile end opposite the firing end, and an inside length extending along said center axis from the firing end to the projectile end, the firearm cartridge case including a cartridge base at the firing end and a circumferential wall extending from said cartridge base about and along the center axis to said projectile end, the cartridge base and the circumferential wall forming an inside cavity;
a projectile-weight having a cartridge end and a tip end opposite the cartridge end, relative to the center axis, the projectile-weight including an aperture passing through the projectile-weight, the projectile-weight configured to seat in the circumferential wall of the firearm cartridge case proximate the firing end of the firearm cartridge case;
a wire line extending into the firearm cartridge case via the cartridge base, out of the firearm cartridge case at the projectile end, and through the projectile-weight via the aperture, the wire line having a fishing pole end and a hook end, each being outside of the firearm cartridge case and the projectile-weight, the wire line including a first attachment loop at the fishing pole end and a second attachment loop at the hook end; and
an annular spacer of substantially the same length as the inside length of the firearm cartridge case, said annular spacer being disposed inside the inside cavity of the firearm cartridge case and about the wire line, and configured to rest against the cartridge base and maintain the projectile-weight positioned substantially outside of the cavity of the firearm.

2. The fishing lure of claim 1, wherein the firearm cartridge case includes an opening at the tip, said opening configured to allow the wire line to run through the length of the firearm cartridge case.

3. The fishing lure of claim 1, wherein the projectile weight is silver in color.

4. The fishing lure of claim 1, where the firearm cartridge case is made of at least one of lead, metal, and plastic.

5. The fishing lure of claim 1, further comprising two spinner blades rotatably affixed to the wire line.

6. The fishing lure of claim 5, wherein each of the two spinner blades are attached to the wire line via a clevis fastener, respectively, each clevis fastener rotatably attached to the wire line.

7. The fishing lure of claim 6, further comprising two fishing lure beads rotatably attached to the wire line, each on opposite sides of the two clevis fasteners.

8. The fishing lure of claim 1, wherein the firearm cartridge case is sized and dimensioned as a 30-caliber cartridge round case.

9. The fishing lure of claim 1, wherein the first attachment loop at the fishing pole end and the second attachment loop at the hook end are separated by a distance of approximately 8 inches.

10. The fishing lure of claim 16, wherein the annular spacer is made of plastic.

11. The fishing lure of claim 1, wherein the projectile weight is held in stasis by the tip end of the firearm cartridge case.

12. The fishing lure of claim 1, wherein the annular spacer is seated adjacent to the projectile weight.

13. The fishing lure of claim 1, wherein the wire line traverses through the annular spacer inside the firearm cartridge casing.

14. The fishing lure of claim 1, wherein the firearm cartridge casing includes an internal wire casing, the wire casing configured to protect the wire line.

15. The fishing lure of claim 1, wherein the annular spacer surrounds the internal wire casing.

16. The fishing lure of claim 15, wherein the wire casing is configured to feed the wire line into the projectile weight.

17. The fishing lure of claim 1, wherein an outside surface of the firearm cartridge case is configured to be equipped with functional ornamental decorations useful for attracting different types of fish.

18. A fishing lure comprising:
a firearm cartridge case having a center axis, a firing end, a projectile end opposite the firing end, and an inside length extending along said center axis from the firing end to the projectile end, the firearm cartridge case including a cartridge base at the firing end and a circumferential wall extending from said cartridge base about and along the center axis to said projectile end, the cartridge base and the circumferential wall forming an inside cavity;
a projectile-weight having a cartridge end and a tip end opposite the cartridge end, relative to the center axis, the projectile-weight including an aperture passing through the projectile-weight, the projectile-weight configured to seat in the circumferential wall of the firearm cartridge case proximate the firing end of the firearm cartridge case;
a wire line extending into the firearm cartridge case via the cartridge base, out of the firearm cartridge case at the projectile end, and through the projectile-weight via the aperture, the wire line having a fishing pole end and a hook end, each being outside of the firearm cartridge case and the projectile-weight, the wire line including a first attachment loop at the fishing pole end and a second attachment loop at the hook end;
an annular spacer of substantially the same length as the inside length of the firearm cartridge case, said annular spacer being disposed inside the inside cavity of the firearm cartridge case and about the wire line, and configured to rest against the cartridge base and maintain the projectile-weight positioned substantially outside of the cavity of the firearm;
two spinner blades rotatably affixed to the wire line, wherein each of the two spinner blades are attached to the wire line via a clevis fastener, respectively, each clevis fastener rotatably attached to the wire line;
two fishing lure beads rotatably attached to the wire line, each on opposite sides of the two clevis fasteners;
wherein the firearm cartridge case includes an opening at the tip, said opening configured to allow the wire line to run through the length of the firearm cartridge case; and
wherein an outside surface of the firearm cartridge case is configured to be equipped with functional and operative ornamental decorations useful for attracting different types of fish.

19. A method of using a fishing lure, the method comprising the steps of:
providing a firearm cartridge case, a projectile weight, a wire line, and an annular spacer
inserting a wire line partially contained in a sheath into a firearm cartridge case, the wire line having a fishing pole end and a hook end, each extending out of the firearm cartridge case, wherein a bottom portion of the sheath contacts an inside bottom wall of the firearm cartridge case, and wherein a top portion of the sheath is located adjacent the top end of the firearm cartridge case;
attaching a first fishing weight to the wire line adjacent an outside bottom end of the firearm cartridge case to prevent movement of the wire line in the direction of the firearm cartridge case;
attaching a fishing hook to the wire line in contact with a bottom end of the sheath to allow for the catching of fish; and
attaching bait to the fishing hook to the fishing hook to lure fish into biting the fishing hook.

20. The method of claim 19, further comprising an optional step of casting the fishing lure.
